(19) United States
(12) Patent Application Publication
(10) Pub. No.: US 2003/0151232 A1
(43) Pub. Date: Aug. 14, 2003

(54) Multiple purpose device to assist physically disabled persons

(76) Inventor: Tianfu Li, Troy, MI (US)

Correspondence Address: Tianfu Li, 1103 Winthrop Dr., Troy, MI, 48083, US

(21) Appl. No.: 10/074,812

(22) Filed: Feb. 14, 2002

(51) Int. Cl. B62B 1/00

(52) U.S. Cl. 280/648

(57) ABSTRACT

A device for assisting a disabled person in performing multiple activities includes bent tubular side frames spaced laterally by a supporting frame, the side frames forming legs supported on wheels and carrying a seat back support, the supporting frame adapted to carry alternately a seat, a commode, a box or other receptacle for holding articles. The frame provides a surface located at an adjustable height above the floor for supporting the user's forearms or elbows, and surfaces for supporting the user's feet above the floor. The device is adapted to be folded easily and compactly.

### BACKGROUND OF THE INVENTION

1. Field of the Invention

This invention relates to the field of wheelchairs and other devices for assisting physically disabled persons to perform activities such as walking, sitting, and carrying articles.

2. Brief Description of the Prior Art

Wheelchairs and other wheeled devices have been developed to assist disabled perform various activities. Usually such devices are adapted to assist in several distinct activities. For example, U.S. Pat. No. 5,538,268 describes a foldable walker having a wheeled base carrying horizontal support arms, which a person may grasp for support while walking with the person's feet located between the legs of the base and arms between with the support arms. The unit includes a hand-operated brake and caster wheels adapted to clearing obstacles.

U.S. Pat. No. 4,748,994 discloses a walker frame having two wheeled legs and two legs that are raised from contact with a floor by the user pressing downward on arms to tilt the frame on its wheels. U.S. Pat. Nos. 5,716,063 and 5,409,028 describe walker having a frame supported on wheels, the frame carrying arms gripped by the user to stabilize the user while walking. The frame of the device of the '028 patent carries a footboard to which a tipping force can be applied to tilt the frame backward and to lift the front wheels from contact with the ground.

U.S. Pat. No. 6,035,462 describes a portable commode having a frame that carries a seat, which is lifted by springs and yields under the body weight of the user to a lowered position over a waste receptacle. U.S. Pat. No. 6,209,901 discloses a wheelchair having a frame that allows the seat, which has a waste elimination opening, to back over the bowl of a commode. U.S. Pat. No. D451,053 shows and describes a wheeled frame that functions as a combined walker and wheelchair.

The devices of the prior art typically are useful for only one specific purpose, usually as a walker to assist and stabilize the user against falling due to loss of balance or slipping, or as a wheelchair to support and transport the user while seated.

However disabled persons, invalids and other users of this equipment are often partially disabled often by arthritis or other ailments that prevent, or make it difficult to use assist equipment that is currently available. For example, some persons have difficulty grasping the equipment with their hands. This impairs their ability to be adequately stabilized while standing and to prevent falling.

### SUMMARY OF THE INVENTION

It is preferred that a device for assisting physically disabled persons be easily used for transporting such a seated person, packages, groceries, etc., or both the person and such articles. It is another object of this invention that the device provide the user stability and support while standing adjacent the device and either holding the device using hand grips or holding the device by placing forearms and leaning lightly on a surface of the device provided to support the forearms.

It is another object of this invention that the device be folded into a compact space simply and easily without adding substantial complexity or weight to the device.

In realizing these objects and advantages a device according to this invention for assisting a disabled person includes a first side frame having a first front leg and first rear leg; a first arm removeably and adjustably attachable to the first side frame, extending upward away from the first legs, supporting a first hand grip or a first surface adapted to support the person's forearms while the person stands adjacent the device; a second side frame substantially parallel to the first side frame and spaced laterally therefrom, having a second front leg and a second rear leg; a second arm removeably attachable to the second side frame, extending upward away from the second legs and supporting a second hand grip or the first surface; a support frame having first and second connecting arms carried on the first and second side frames, respectively, and laterally directed connecting arms connected to the first and second connecting arms, the support frame being adapted to carry alternately a commode, a seat having an opening and adapted to back over the bowl of a commode, a seat, or a box for holding articles having a closing top providing a seating surface.

The device may include a first caster wheel coupled to front leg of the first side frame; a second caster wheel coupled to front leg of the second side frame; and first and second wheels coupled to the rear legs of the first and second side frames, respectively.

Various accessories suited for use with the device include arm rests supported on the side frames for supporting the person's forearms while the person is seated on the device, a seat back for supporting a person's back while seated on the device, and foot supports carried on the side frames, supported there for pivotal movement into a space between the side frames, alternately providing a surface to support the person's foot in a plane above a surface of a floor or ground and rotating said surface away from said plane where said foot is supported. The device is adapted to be folded easily and compactly.

### BRIEF DESCRIPTION OF THE DRAWINGS

FIG. 1 is a side isometric view of the device according to this invention arranged for operation as a wheelchair.

FIG. 2 is a side isometric view of the device according to this invention arranged for operation as a commode.

FIG. 3 is a side isometric view of the device according to this invention arranged for operation as a combined walker, carrying cart and seat.

FIG. 4 is a side view of the device of FIG. 3 having lowered armrests and a frame that supports a shopping basket located below a hinged seat partially covering the basket top.

FIG. 5 is a side view of the device of FIG. 2 having raised armrests and a frame that supports a commode waste receptacle located below a seat.

FIG. 6 is a side isometric view of the device according to this invention having a frame that carries an elevated surface for supporting a walking user.

FIG. 7 is a side isometric view of the device according to this invention folded into a compact space.

FIG. 8 is view of a portion of a commode seat showing the seat panel, clip and Velcro surface.

FIG. 9 is a front view of a central portion of a commode seat.

FIG. 10 is a cross section of a commode seat taken at plane 10-10 of FIG. 2.

FIG. 11 is a view of a commode seat and central panel covering a central opening.

FIG. 12 is a front view of a commode seat and commode waste receptacle assembly suited for use with the device of this invention.

FIG. 13 is an isometric side view of the footrests and their attachment to the front legs.

FIG. 14 is a side view of this invention used as a bedside commode with the back support in place.

FIG. 15 is a side view of this invention used as a commode seat in place over a toilet.

### DESCRIPTION OF THE PREFERRED EMBODIMENT

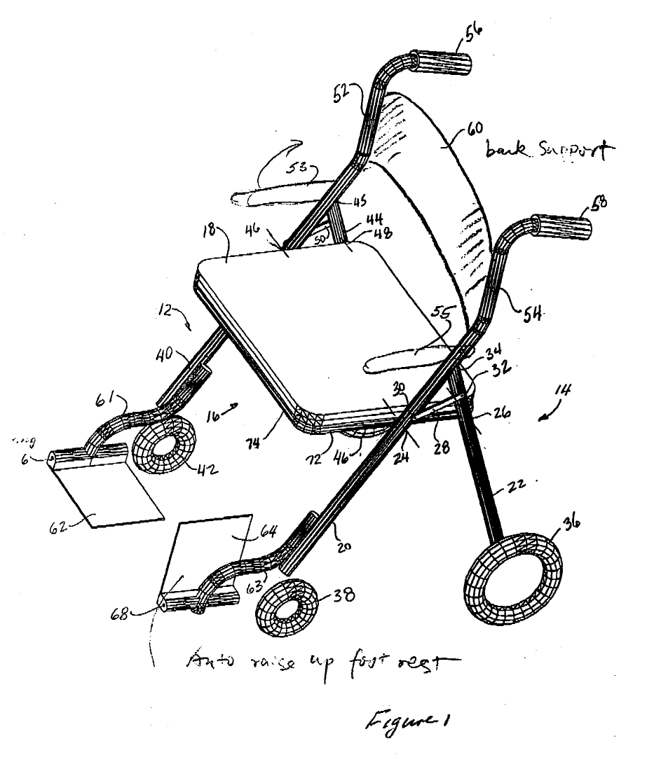

Referring first to FIG. 1 a device according to the invention includes a first side frame 12 and second side frame 14, which are spaced apart laterally and connected mutually either by a support frame 16, or a seat 18 having a support frame located below and fixed to the seating surface, or a combination of these. The left-hand side frame 14 includes a forward leg 20 and rear leg 22. The support frame 16 is supported on front leg 20 at a pin connection 24 and is supported on rear leg 22 at a pin connection 26. Legs 20 and 22 are further interconnected by a strap 28, which is pinned at 30 and 32 to the front and rear legs 20,22, respectively. The upper end 34 of rear leg 26 contacts the adjacent lower surface of the front leg 20 when the device is unfolded and in the position shown in FIGS. 1-6.

The lower end of leg 22 is supported on a wheel 36 mounted on leg 22 for rotation about a horizontal axis. The lower end of leg 20 is supported on a caster wheel 38 for rotation about a horizontal axis and for revolution about a vertical axis, thereby allowing the device to be easily steered.

In a similar way, the right-hand side frame 12 includes a forward front leg 40 supported on a caster wheel 42 and a rear leg 44 supported on a wheel 46, which is mounted on leg 44 for rotation about a horizontal axis. Legs 40 and 44 are similarly joined either to support frame 16 or to seat 18 by pin connections 46,48, respectively. A strap 50 is pinned to leg 40 and to leg 44, as FIG. 1 shows with respect to strap 28.

Extending upward from the upper ends of legs 20, 40 are arms 52,54, which are removeably and adjustably fixed to those legs so that the height of hand grips 56, 58, carried on the ends of the arms are adjustable with respect to ground.

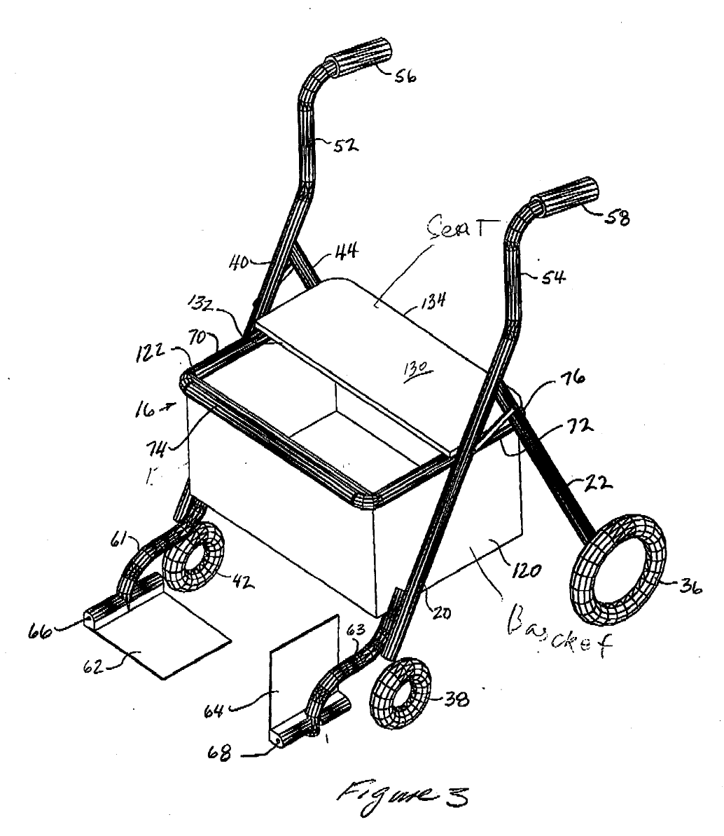

Attached to arms 52,54 are right side and left side armrests 53,55 located to support a user seated on seat 18. The armrests can be raised from the position of FIG. 4 to that of FIG. 5 by rotating the each armrest individually with light manual force. Preferably each armrest is held in the raised position by a detent and its rotation downward is limited by a stop surface supported on the respective arm 52,54. The armrests are preferably adapted for easy removal from the arms 52,54.

A back support 60 extends between arms 52,54 and has each of its lateral ends connected, respectively, to an arm 52,54. Preferably support 60 is located relative to seat 18 so that the user's back is supported by support 60 while the user is seated facing either forward or rearward. The support is preferably adapted for easy removal from the first and second side frames.

The forward legs 20,40 carry foot support assemblies, which include foot support surfaces 62,64 located in the space between forward legs 20,40, and support brackets 61,63, removeably fixed to the forward legs so that the position of the support surfaces 62,64 can be easily adjusted in relation to the respective leg, ground and floor. Each of the support surfaces 62,64 is resiliently urged to rotate about axes 66,68 by torsion springs to a raised position, to the plane of surface 64. The force of the torsion springs can be easily overcome with a light, downward manual force applied to the support surfaces so they can be rotated downward to the position of surface 62. Further details of the footrests are described with reference to FIG. 13.

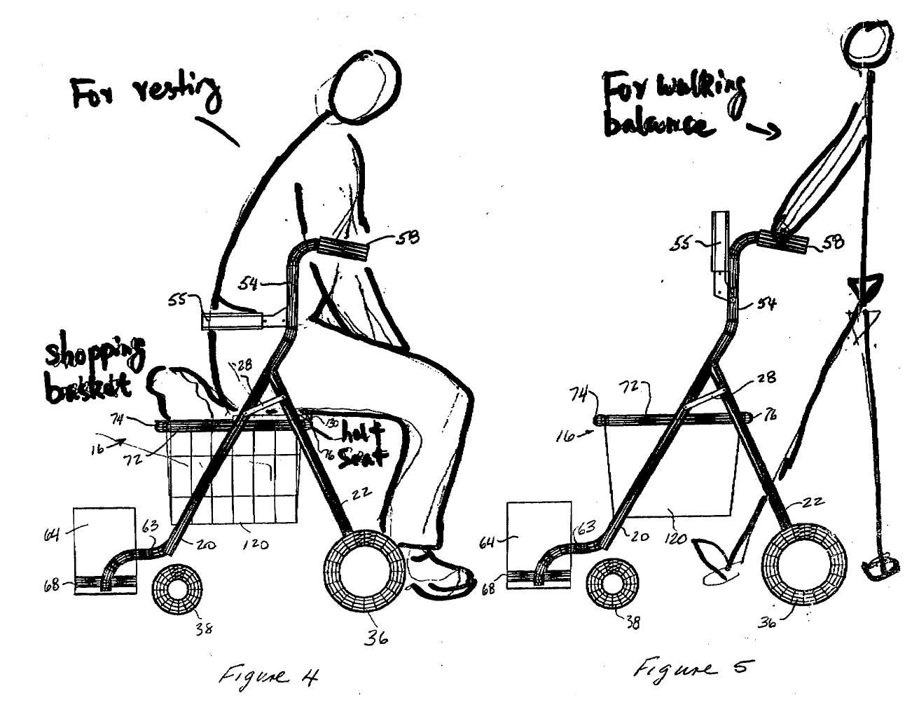

The device arranged as shown in FIG. 6 is particularly well adapted for use by a person who has difficulty gripping the handgrips of the device configured as in FIG. 1. A support frame 16 includes left-hand and right-hand members 70,72, respectively, front cross member 74, and rear cross member 76. The left side member 72 is joined to the front leg 20 and rear of leg 22 at front and rear pin connections 24,26, respectively. Similarly, the right side member 70 is joined to front leg 40 and rear leg 44 at front and rear pin connections 46,48, respectively. Support frame 16 surrounds a substantially planar unobstructed area, the upper surface of the longitudinal and lateral members 70-76, into which area various accessories are placed and supported by the frame. That area is preferably in a substantially horizontal plane, but can be inclined somewhat with respect to the horizontal.

An additional pair of arms 80,82, removeably and adjustably carried on the upper ends of legs 20, 40 and extending vertically upward therefrom support an upper frame 90 comprising a right-hand lateral member 84, a left-hand lateral member 86 and an upper cross member 88 extending between and fixed to members 84, 86. The upper frame 90 carries a support surface 92. The length of arms 80,82 is adjusted preferably so that the user's forearms while resting on the upper surface of surface 92 can be used to guide the device as the user walks behind it. In this way the device both supports and stabilizes the user while standing and walking. Preferably frames 12, 14, 16 and arms 52, 54, 80, 82 are formed of thin tubular metal.

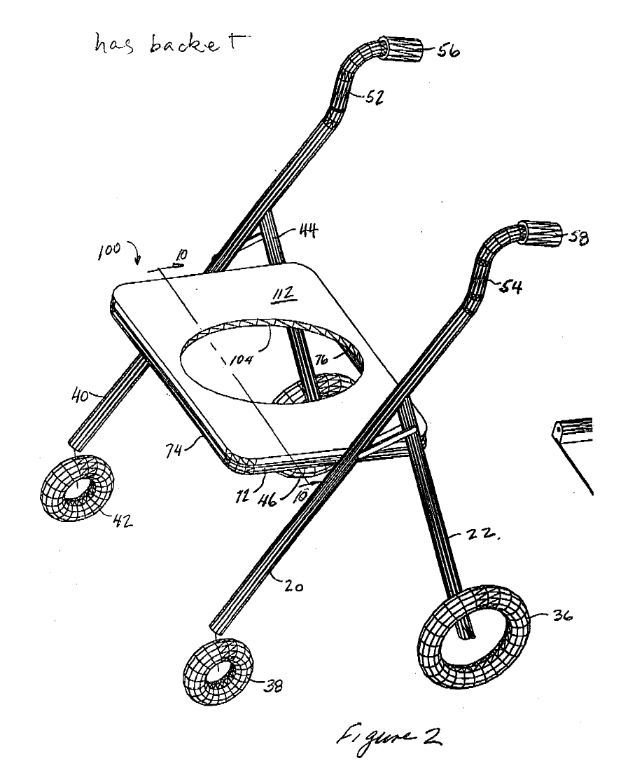

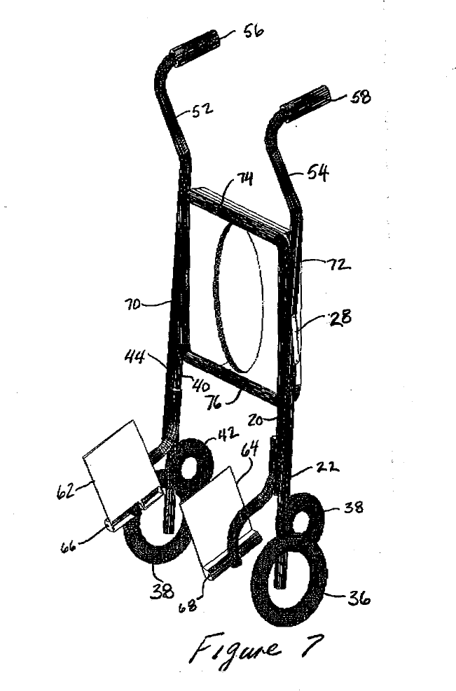

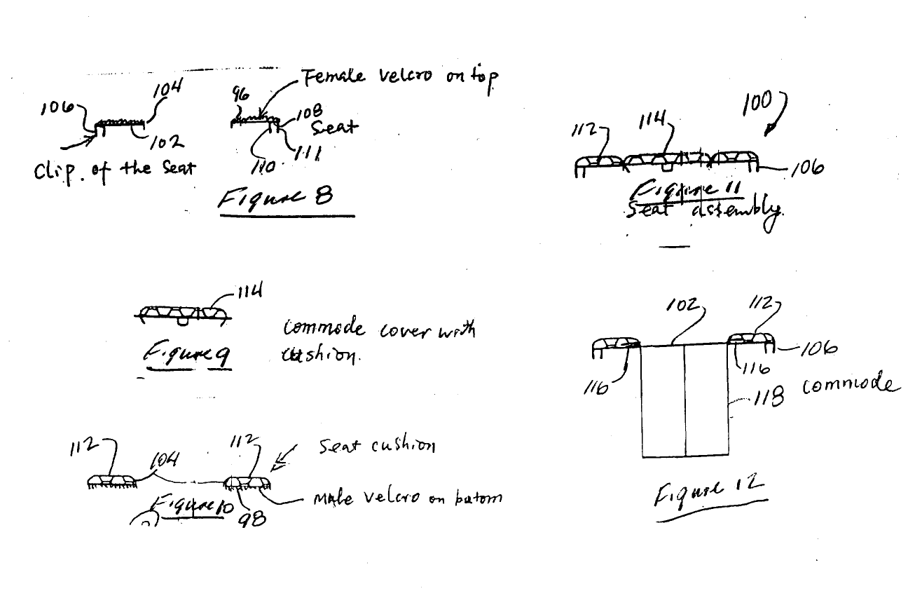

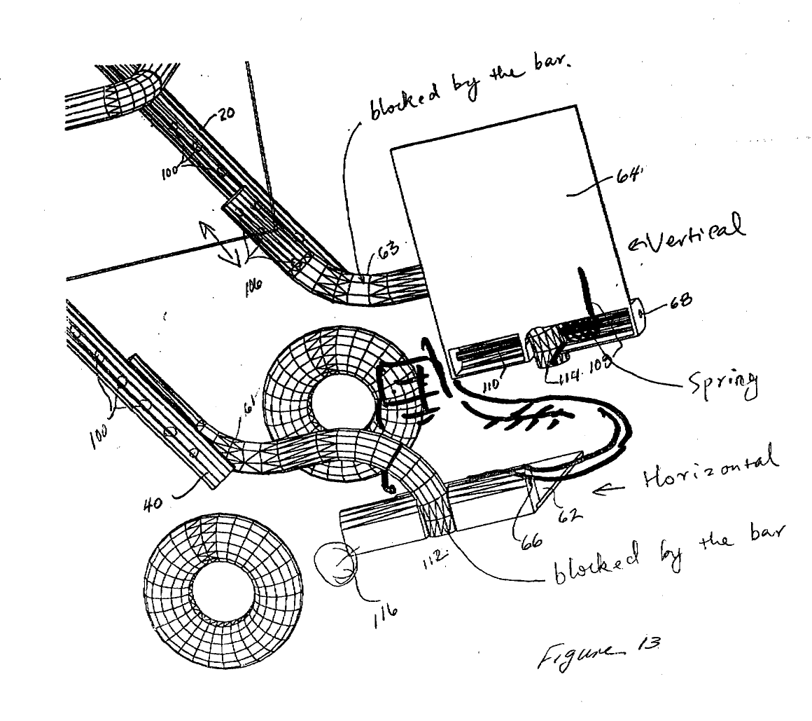

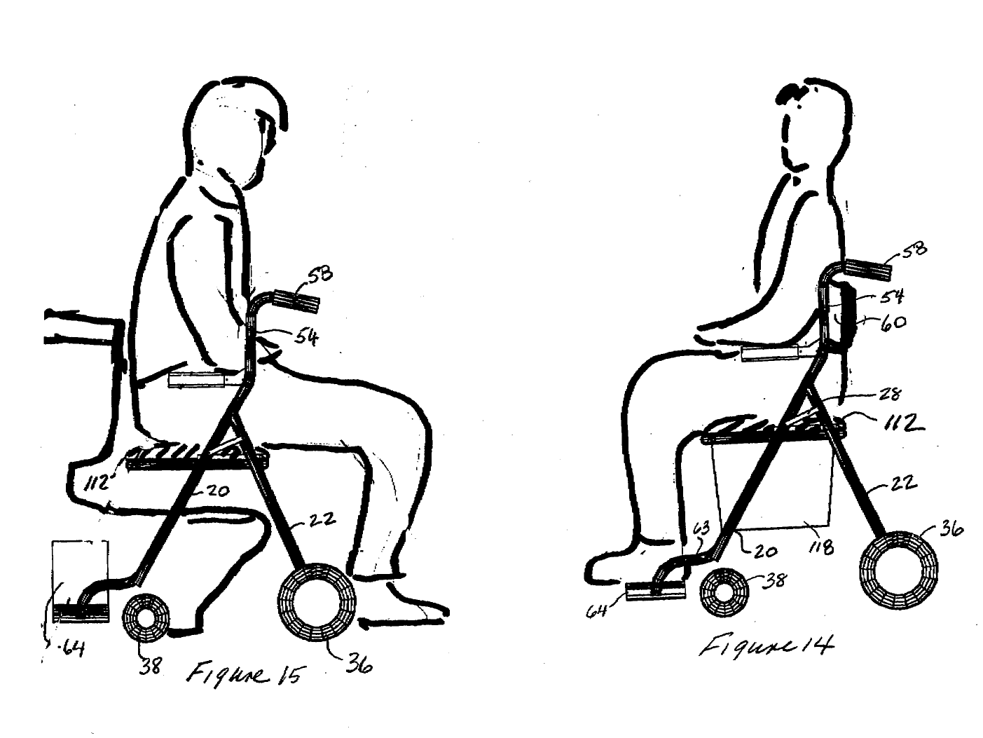

FIG. 2 shows the device with the foot supports removed, seat 18 removed and replaced with a commode seat assembly 100. The height of the seat and space between the legs 20,40 permits the device to roll into position over a toilet. Seat assembly 100, whose details are shown in FIGS. 8-12, includes a panel 102 having a central opening 104. The panel carries clips 106, located on the periphery of its lower surface, and is covered on the upper surface with a Velcro surface 96. Each clip 106 includes a web 108 contacting and fixed to the lower surface of panel 102, and downward directed fingers 110, 111, which straddle and grip the members 70-76 of the support frame 16. A seat cushion 112 having substantially the same planform shape as that of the upper surface of panel 102, carries a complementary Velcro surface 98 on its lower surface, surface 98 being suited to mate with and grip the Velcro surface 96. A cushioned commode cover 114 is sized to fit over and to cover the central opening 104 and to overlap the portion of the upper surface of panel 102 adjacent the central opening. Similarly an outwardly directed flange 116 surrounding the open upper rim of a commode waste receptacle 118 overlaps a portion of the upper surface of panel 102. The receptacle 118 is held in position on the device and supported on the panel 102 below the central opening 104 of seat cushion 112 when the device is used as a commode.

FIG. 3 shows an alternative form of the invention, adapted to assist the user in carrying packages, to support and stabilize the user while walking, and to provide a seating surface. In the configuration of FIG. 3, frame 16 carries on its front, rear and lateral members 70-76 a basket 120 or box having walls fitted between the members of the frame 16. The basket includes a lip or flange 122 that overlaps and extends along the upper edge of the basket and outward from its interior, the lip extending over the upper surfaces of the members 70-76 of the support frame. In this way, the basket depends from the support frame and is easily installed in the device by placing the side of the basket 120 between the support members and lowering it into supporting contact on the frame. The basket and its contents are removed from the device by lifting the basket from the frame.

The upper opening of the basket is covered with a split cover 130, hinged along an axis 132 located about midway between the front and rear edges of the basket and the front and rear cross members 74,76 of support frame 16. The seat provides a flat surface for supporting a seated user whether the cover is partially open, as shown in FIG. 3, or closed entirely cover the basket top.

Support frame 16 supports the seat 18, basket 120, commode seat 112, and commode seat with the commode waste receptacle 118 attached, without altering the device except for alternately removing one of these accessories and replacing it with any of the other accessories. For example, FIG. 4 shows a shopping basket supported on the frame 16; FIG. 5 shows the shopping basket removed and a commode seat and waste receptacle supported on the frame.

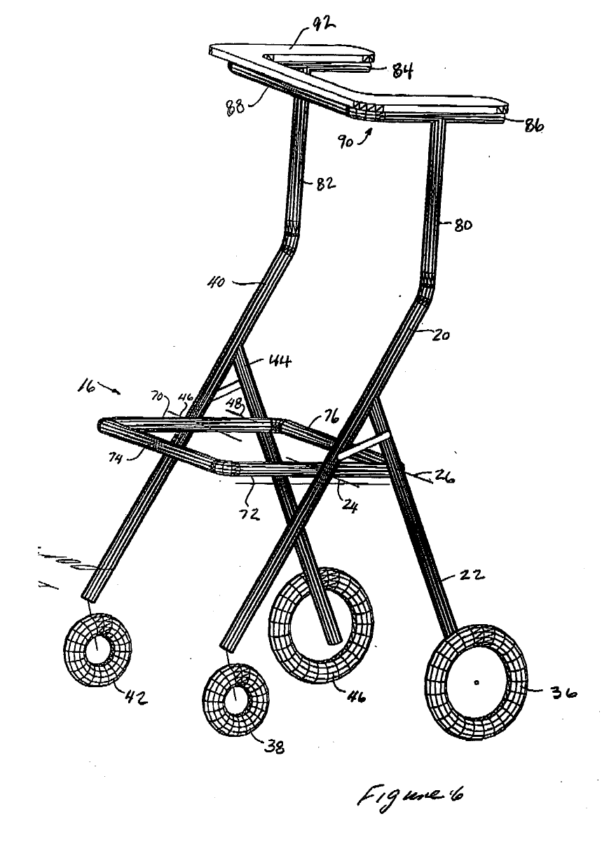

FIG. 7 shows the device in the arrangement of FIG. 1 folded into a compact space. The transition of the device from the extended, useable form of FIG. 1 to the folded condition of FIG. 7 occurs by raising front cross member 74 or the front of the seat 18 upward to a position between the arms 52,54, thereby forcing the rear cross member 76 or the rear of the seat downward to a position between the arms. This action draws the front legs 20,40 rearward into substantial alignment with legs 22,44 so that wheels 38 and 42 are located between wheels 36 and 38, respectively. During the folding transition, legs 22,44 are lowered and legs 20,40 are raised due to the guiding effect of straps 28 and 50, thereby removing the contact at 34,45 between the front legs and rear legs.

Referring next to FIG. 13, the lower end of each front leg 20,40 is formed with a series of spaced holes 100 through the legs and extending partially along the length of the length of the legs. Each leg carries a footrest support bracket 61,63 formed with holes 106,108, spaced mutually the same distance as the mutual spacing of holes 100. A bolt or pin is passed through a hole 106 and a hole 100. In this way, the foot support brackets can be adjusted on the front legs to a position where the foot supports 62,64 comfortably support the user while seated.

Each foot support is continually urged to the position of support 64 in FIG. 8, preferably inclined slightly inward from the vertical plane by a small angle to allow the user to place his foot behind the foot support and to press it downward to the position of support 62 in FIG. 8. Each support is biased upward by a torsion spring 108, surrounding a rod 110 aligned with axes 66,68. Rod 110 passes through lower ends 112, 114 of support brackets 61,63, respectively.

Alternatively a counterweight 116, carried on foot supports 62,64 urges each support to rotate to the position of support 64 until it is pressed downward by the user's foot resting on the support.

The force of the springs 108 or counterweights 116 is light enough to allow the user to easily rotate the supports 62,64 downward to the service position. The effect of raising the supports 62,64 by rotation about the pivot axes provides a space between the front legs for the user to place his feet while transferring to and from the device, and to clear a floor-mounted commode.

The various seats 18, 112, 130 for use with the device have clips, similar to the clips 106 located on the underside of panel 102, contacting and fixed to their lower surfaces. Each clip 106 includes a web 108 contacting and fixed to the lower surface of the respective seat, and downward directed fingers 110, 111, which straddle and grip the members 70-76 of the support frame 16. This arrangement facilitates removal and installation of the various accessories.

The device according to this invention can be easily changed to assist in performing many tasks. For example, by merely installing one of the seat options and a commode waste receptacle on the support frame, the device can be used as a bedside commode. By removing the waste receptacle, the device can be rolled into position over a toilet for use as a commode seat. The device can be used to carry packages while a person is seated above the shopping basket, by removing the commode seat, installing a shopping basket on the support frame and placing a seat-top over the basket. The device can be used as a wheelchair by placing a cushioned seat on the support frame and installing footrests and armrests on the side frames. These changes in configuration of the device to assist the user in performing particular tasks are easy to accomplish by the user and require little time, effort or assistance from other persons.

Although the form of the invention shown and described here constitutes the preferred embodiment of the invention, it is not intended to illustrate all possible forms of the invention. Words used here are words of description rather than of limitation. Various changes in the form of the invention may be made without departing from the spirit and scope of the invention as disclosed.

I claim:

1. A device for assisting a person in performing various tasks, comprising:
a first side frame including a first front leg, and a first rear leg connected to said front leg for movement relative thereto;
a first arm removeably attached to the first side frame, extending upward away from the first side frame;
a second side frame substantially parallel to the first side frame and aligned longitudinally therewith, including a second front leg, and second rear leg connected to said second front leg for movement relative thereto;
a second arm removeably attached to the second side frame, extending upward away from the second side frame; and
a support frame including
a first member extending substantially longitudinally, connected to the first front leg and first rear leg,
a second member extending substantially longitudinally, connected to the second front leg and second rear leg,
a front member extending laterally between and connected to the first member and second member, and
a rear member spaced longitudinally from the front member, extending laterally between and connected to the first member and second member.

2. The device of claim 1, wherein:
the first arm is adapted for adjustment of its position relative to the first side frame, and supports a first hand grip; and
the second arm is adapted for adjustment of its position relative to the second side frame, and supports a second hand grip, whereby a person holding the handgrips and standing adjacent the device is stabilized against falling.

3. The device of claim 1, wherein:
the first arm is adapted for adjustment of its position relative to the first side frame, and supports a first surface adapted to support the person's forearms while the person stands adjacent the device; and
the second arm is adapted for adjustment of its position relative to the second side frame, and supports said first surface.

4. The device of claim 1 adapted to assist a person in carrying articles, wherein the support frame surrounds an unobstructed area, the device further comprising:
a container suspended from the support frame below said area and adapted to hold articles placed in the container, the support frame supporting the container, its contents, and articles located on the support frame.

5. The device of claim 1, wherein:
the first member is supported on the first front leg and first rear leg for rotation relative thereto;
the first front leg and first rear leg are connected mutually for rotation relative thereto;
the second member is supported on the second front leg and second rear leg for rotation relative thereto; and
the second front leg and second rear leg are connected mutually for rotation relative thereto, whereby said front legs and said rear legs can be folded into a compact space by raising the front member of the support frame and lowering the rear member of the support frame.

6. The device of claim 1, further comprising:
a first caster wheel coupled to the front leg of the first side frame;
a second caster wheel coupled to the front leg of the second side frame;
first and second wheels coupled to the rear legs of the first and second side frames, respectively.

7. The device of claim 1, further comprising:
a first armrest supported on the first side frame and a second armrest side supported on the second side frame, for supporting the person's forearms while the person is seated on the device.

8. The device of claim 1, further comprising:
a seat back having a first end supported on the first side frame and a second end supported on the second side frame, adapted to support a person's back while seated on the device.

9. The device of claim 1, wherein:
the first side frame further comprises a first foot support carried on the first front leg, said first foot support providing a surface that moves to a plane above a surface of a floor or ground position where a foot of the user can be supported thereon while the user is seated, and being continually urged to move out of said plane; and
the second side frame further comprises a second foot support carried on the second front leg, said first foot support providing a surface that moves to a plane above a surface of a floor or ground position where a foot of the user can be supported thereon while the user is seated, and being continually urged to move out of said plane.

10. The device of claim 1, wherein the first side frame further comprises:
a first front leg inclined downward and forward from said first hand grip and having a first connection where the seat or support frame is pinned to the first front leg for rotation relative thereto;
a first rear leg having an upper end contacting the first front leg, inclined downward and rearward from said contact with the first front leg; and
the second side frame further comprises:
a second front leg inclined downward and forward from said second hand grip and having a second connection where the seat or support frame is pinned to the second front leg for rotation relative thereto;
a second rear leg having an upper end contacting the second front leg, inclined downward and rearward from said contact with the second front leg.

11. A device for assisting a person in performing various tasks, comprising:
a first side frame having a first front and rear legs;
a first arm removeably attached to the first side frame, extending upward away from the first side frame;
a second side frame substantially parallel to the first side frame and spaced laterally therefrom, having second front rear legs;
a second arm removeably attached to the second side frame, extending upward away from the second side frame; and
a support frame including
a first member extending substantially longitudinally, connected to the first front leg and first rear leg,
a second member extending substantially longitudinally, connected to the second front leg and second rear leg,
a front member extending laterally between and connected to the first member and second member,
a rear member spaced from the front member, extending laterally between and connected to the first member and second member.

12. The device of claim 11, wherein said support frame carries a commode seat located in relation to ground so that the device can carry said seat over a commode.

13. The device of claim 11, wherein said support frame carries a seat.

14. The device of claim 11, wherein said support frame carries a container adapted to hold articles located therein and thereon.

15. The device of claim 11, wherein said support frame carries a box having a top that closes the box and provides a seating surface.

16. The device of claim 15, wherein said top includes a first top closing a first portion of the box, a second top located adjacent the first top and closing a second portion of the box, the first and second tops being mutually hinged and providing a seating surface when the box is closed by both the first and second tops and when the box is closed by the first top or second top.

17. The device of claim 11, further comprising:
a first caster wheel coupled to the front leg of the first side frame;
a second caster wheel coupled to the front leg of the second side frame;
first and second wheels coupled to the rear legs of the first and second side frames, respectively.

18. The device of claim 11, further comprising:
the first member is supported on the first front leg and first rear leg for rotation relative thereto;
the first front leg and first rear leg are connected mutually for rotation relative thereto; and
the second member is supported on the second front leg and second rear leg for rotation relative thereto; and
the second front leg and second rear leg are connected mutually for rotation relative thereto, whereby said front legs and said rear legs can be folded into a compact space by lifting the front member of the support frame and lowering the rear member of the support frame.

19. The device of claim 11, wherein:
the first side frame further comprises a first foot support carried on the first front leg, said first foot support providing a surface that moves to a position where a foot of the user can be supported thereon in a plane above a surface of a floor or ground while the user is seated in the seat, and being continually urged to move from said plane; and
the second side frame further comprises a second foot support carried on the second front leg, said second foot support providing a surface that moves to a position where a foot of the user can be supported thereon in a plane above a surface of a floor or ground while the user is seated in the seat, and being continually urged to move from said plane.

20. A device for assisting a person in performing various tasks, comprising:
a first side frame having a first front leg and a first rear leg;
a first caster wheel coupled to the first front leg;
a first arm removeably attached to the first side frame, extending upward away from the first side frame, and supporting thereon a member of a first group consisting of a first hand grip and a first surface adapted to support the person's forearms while the person stands adjacent the device;
a second side frame substantially parallel to the first side frame and spaced laterally therefrom, having a second front leg and a second rear leg;
a second caster wheel coupled to the second front leg;
a second arm removeably attached to the second side frame, extending upward away from the second side frame, and supporting thereon a member of a second group consisting of a second hand grip and said first surface;
first and second wheels coupled to the first and second rear legs, respectively;
a first foot support carried on the first front leg;
a second foot support carried on the second front leg;
a support frame including
a first member extending substantially longitudinally, connected to the first front leg and first rear leg,
a second member extending substantially longitudinally, connected to the second front leg and second rear leg,
a front member extending laterally between and connected to the first member and second member,
a rear member spaced from the front member, extending laterally between and connected to the first member and second member.

21. A device for supporting and transporting a person seated in the device, comprising:
a first side frame having a first front leg and a first rear leg;
a first wheel coupled to the first front leg and a second wheel coupled to the first rear leg;
a second side frame substantially parallel to the first side frame and spaced laterally therefrom, having a second front leg and a second rear leg;
a third wheel coupled to the second front leg and a fourth wheel coupled to the second rear leg;
a seat supported on the first and second side frames; and
a first foot support carried on the first front leg, said first foot support providing a surface that moves to a position where a foot of the user can be supported thereon while the user is seated in the seat, and being continually urged to move away from said position.

22. The device of claim 21, wherein said first foot support further comprises:
a bracket carried on the first front leg for removal therefrom and adjustment of position relative thereto;
a foot support surface supported on said bracket for pivoting movement about an axis; and
means continually biasing the foot support surface to pivot toward the first front leg and away from the second front leg.

23. The device of claim 22 wherein the biasing means comprises a member of a group consisting of a torsion spring, and a counterweight carried on the first foot support and spaced from said axis.
